(19) United States
(12) Patent Application Publication
(10) Pub. No.: US 2022/0239915 A1
(43) Pub. Date: Jul. 28, 2022

(54) PERCEPTUAL ADAPTIVE QUANTIZATION AND ROUNDING OFFSET WITH PIECE-WISE MAPPING FUNCTION

(71) Applicant: REALNETWORKS, INC., Seattle, WA (US)

(72) Inventors: Xin HUANG, Shanxi (CN); Reza RASSOOL, Seattle, WA (US); Leon SHI, Beijing (CN); Chao KUANG, Seattle, WA (US)

(21) Appl. No.: 17/617,242

(22) PCT Filed: Jun. 10, 2019
(86) PCT No.: PCT/CN2019/090563

§ 371 Date: Dec. 7, 2021

(51) Int. Cl. H04N 19/124; H04N 19/176; H04N 19/136

(52) U.S. Cl. CPC H04N 19/124; H04N 19/136; H04N 19/176

(57) ABSTRACT

An unencoded video frame of a sequence of video frames is encoded to generate an encoded bit-stream representative of the unencoded video frame. The unencoded video frame is divided into a plurality of coding blocks. A local sensitivity measurement may be determined for each of the coding blocks. Based on the local sensitivity measurement, an encoder may determining one or more quantization parameters, one or more adaptive rounding offsets, or one or more quantization steps. The determined parameters may be provided to a quantizer of a video encoder for use in encoding the coding block of the unencoded video frame.

### TECHNICAL FIELD

The present disclosure generally relates to video processing, and more particularly, to video encoding and decoding systems and methods.

### DESCRIPTION OF THE RELATED ART

The advent of digital multimedia such as digital images, speech/audio, graphics, and video have significantly improved various applications as well as opened up brand new applications due to relative ease by which it has enabled reliable storage, communication, transmission, and, search and access of content. Overall, the applications of digital multimedia have been many, encompassing a wide spectrum including entertainment, information, medicine, and security, and have benefited the society in numerous ways. Multimedia as captured by sensors such as cameras and microphones is often analog, and the process of digitization in the form of Pulse Coded Modulation (PCM) renders it digital. However, just after digitization, the amount of resulting data can be quite significant as is necessary to re-create the analog representation needed by speakers and/or TV display. Thus, efficient communication, storage or transmission of the large volume of digital multimedia content requires its compression from raw PCM form to a compressed representation. Thus, many techniques for compression of multimedia have been invented. Over the years, video compression techniques have grown very sophisticated to the point that they can often achieve high compression factors between 10 and 100 while retaining high psycho-visual quality, often similar to uncompressed digital video.

While tremendous progress has been made to date in the art and science of video compression (as exhibited by the plethora of standards bodies driven video coding standards such as MPEG-1, MPEG-2, H.263, MPEG-4 part2, MPEG-4 AVC/H.264, HEVC, AV1, MPEG-4 SVC and MVC, as well as industry driven proprietary standards such as Windows Media Vide©, RealVideo, On2 VP, and the like), the ever increasing appetite of consumers for even higher quality, higher definition, and now 3D (stereo) video, available for access whenever, wherever, has necessitated delivery via various means such as DVD/BD, over the air broadcast, cable/satellite, wired and mobile networks, to a range of client devices such as PCs/laptops, TVs, set top boxes, gaming consoles, portable media players/devices, smartphones, and wearable computing devices, fueling the desire for even higher levels of video compression. In the standards-body-driven standards, this is evidenced by the recently started effort by ISO MPEG in High Efficiency Video coding which is expected to combine new technology contributions and technology from a number of years of exploratory work on H.265 video compression by ITU-T standards committee.

All aforementioned standards employ a general intra/interframe predictive coding framework in order to reduce spatial and temporal redundancy in the encoded bitstream. The basic concept of interframe prediction is to remove the temporal dependencies between neighboring pictures by using block matching method. At the outset of an encoding process, each frame of the unencoded video sequence is grouped into one of three categories: I-type frames, P-type frames, and B-type frames. I-type frames are intra-coded. That is, only information from the frame itself is used to encode the picture and no inter-frame motion compensation techniques are used (although intra-frame motion compensation techniques may be applied).

The other two types of frames, P-type and B-type, are encoded using inter-frame motion compensation techniques. The difference between P-picture and B-picture is the temporal direction of the reference pictures used for motion compensation. P-type pictures utilize information from previous pictures in display order, whereas B-type pictures may utilize information from both previous and future pictures in display order.

For P-type and B-type frames, each frame is then divided into blocks of pixels, represented by coefficients of each pixel's luma and chrominance components, and one or more motion vectors are obtained for each block (because B-type pictures may utilize information from both a future and a past displayed frame, two motion vectors may be encoded for each block). A motion vector (MV) represents the spatial displacement from the position of the current block to the position of a similar block in another, previously encoded frame (which may be a past or future frame in display order), respectively referred to as a reference block and a reference frame. The difference between the reference block and the current block is calculated to generate a residual (also referred to as a “residual signal”). Therefore, for each block of an inter-coded frame, only the residuals and motion vectors need to be encoded rather than the entire contents of the block. By removing this kind of temporal redundancy between frames of a video sequence, the video sequence can be compressed.

To further compress the video data, after inter or intra frame prediction techniques have been applied, the coefficients of the residual signal are often transformed from the spatial domain to the frequency domain (e.g. using a discrete cosine transform (“DCT”) or a discrete sine transform (“DST”)). For naturally occurring images, such as the type of images that typically make up human perceptible video sequences, low-frequency energy is always stronger than high-frequency energy. Residual signals in the frequency domain therefore get better energy compaction than they would in spatial domain. After forward transform, the coefficients and motion vectors may be quantized and entropy encoded.

On the video decoder side, inversed quantization and inversed transforms are applied to recover the spatial residual signal. These are typical transform/quantization processes in all video compression standards. A reverse prediction process may then be performed in order to generate a recreated version of the original unencoded video sequence. Generally, all of the compression tools on the decoder side are normative and part of the encoding loop. Thus, the output or “output frame” of the decoder is identical to a “reconstruct frame” generated by an encoder. Any changes to the decoder may cause quality degradation and a mismatch between the output frame of the decoder and the reconstruct frame of the encoder.

In past standards, the blocks used in coding were generally sixteen by sixteen pixels (referred to as macroblocks in many video coding standards). However, since the development of these standards, frame sizes have grown larger and many, devices have gained the capability to display higher than “high definition” (or “HD”) frame sizes, such as 1920×1080 pixels. Thus it may be desirable to have larger blocks to efficiently encode the motion vectors for these frame size, e.g. 64×64 pixels. However, because of the corresponding increases in resolution, it also may be desirable to be able to perform motion prediction and transformation on a relatively small scale, e.g. 4×4 pixels.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements, and may have been solely selected for ease of recognition in the drawings,

FIG. 1 illustrates an exemplary video encoding/decoding system, according to one non-limiting illustrated implementation.

FIG. 2 illustrates several components of an exemplary encoding device, according to one non-limiting illustrated implementation.

FIG. 3 illustrates several components of an exemplary decoding device, according to one non-limiting illustrated implementation.

FIG. 4 illustrates a block diagram of an exemplary video encoder, according to one non-limiting illustrated implementation.

FIG. 5 illustrates a block diagram of an exemplary video decoder, according to one non-limiting illustrated implementation.

FIG. 6 illustrates a block diagram of an exemplary video encoder that utilizes local sensitivity measurement and piece-wise delta quantization parameter (QP) mapping, according to one non-limiting illustrated implementation.

FIG. 7 illustrates a block diagram of an exemplary video encoder that utilizes local sensitivity measurement, piece-wise delta QP mapping and/or adaptive rounding offset, according to one non-limiting illustrated implementation.

FIG. 8 illustrates a graph of a delta QP piece-wise mapping function, according to one non-limiting illustrated implementation.

FIG. 9 illustrates a formula used for determining transform coefficients and a dead zone area caused by quantization, according to one non-limiting illustrated implementation.

FIG. 10A illustrates an example adaptive rounding offset matrix for high motion intensity in the horizontal direction, according to one non-limiting illustrated implementation.

FIG. 10B illustrates an example adaptive rounding offset matrix for high motion intensity in the vertical direction, according to one non-limiting illustrated implementation.

FIG. 11 illustrates a zig-zag sequence for a quantization matrix, according to one non-limiting illustrated implementation.

FIGS. 12A-12C illustrates examples of an implementation that provides an adaptive quantization step, according to one non-limiting illustrated implementation.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures associated with computer systems, server computers, and/or communications networks have not been shown or described in detail to avoid unnecessarily obscuring descriptions of the implementations.

Unless the context requires otherwise, throughout the specification and claims that follow, the word “comprising” is synonymous with “including,” and is inclusive or open-ended (i.e., does not exclude additional, unrecited elements or method acts).

Reference throughout this specification to “one implementation” or “an implementation” means that a particular feature, structure or characteristic described in connection with the implementation is included in at least one implementation. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

The headings and Abstract of the Disclosure provided herein are for convenience only and do not interpret the scope or meaning of the implementations.

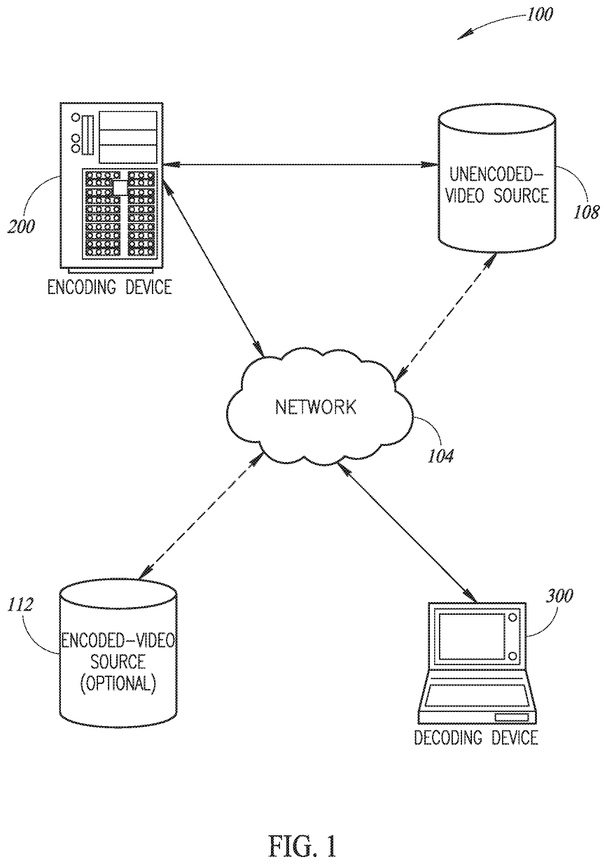

One or more implementations of the present disclosure are directed to systems and methods to improve encoding and decoding of video by providing perceptual adaptive quantization and rounding offset with a piece-wise mapping function. The various features of the implementations of the present disclosure are discussed below with reference to FIGS. 1-12C.

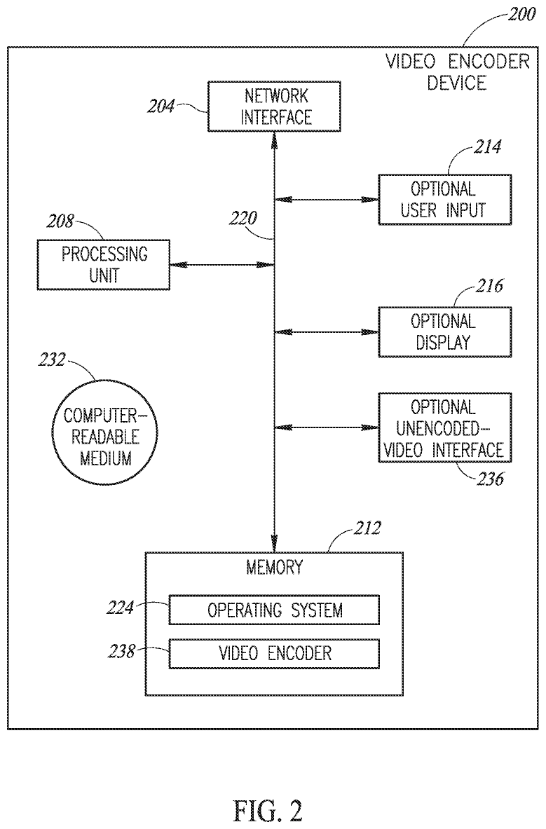

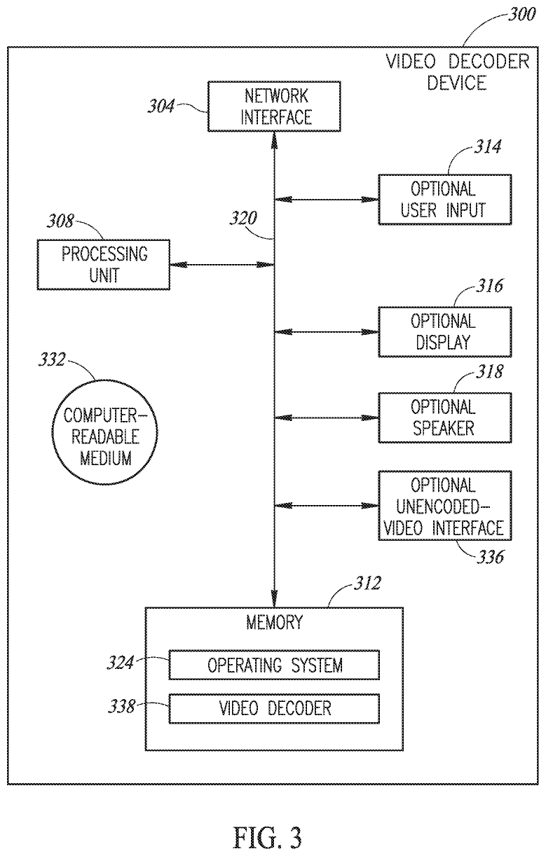

FIG. 1 illustrates an exemplary video encoding/decoding system 100 in accordance with at least one embodiment. Encoding device 200 (illustrated in FIG. 2 and described below) and decoding device 300 (illustrated in FIG. 3 and described below) are in data communication with a network 104. Encoding device 200 may be in data communication with unencoded video source 108, either through a direct data connection such as a storage area network (“SAN”), a high speed serial bus, and/or via other suitable communication technology, or via network 104 (as indicated by dashed lines in FIG. 1). Similarly, decoding device 300 may be in data communication with an optional encoded video source 112, either through a direct data connection, such as a storage area network (“SAN”), a high speed serial bus, and/or via other suitable communication technology, or via network 104 (as indicated by dashed lines in FIG. 1). In some embodiments, encoding device 200, decoding device 300, encoded-video source 112, and/or unencoded-video source 108 may comprise one or more replicated and/or distributed physical or logical devices. In many embodiments, there may be more encoding devices 200, decoding devices 300, unencoded-video sources 108, and/or encoded-video sources 112 than are illustrated.

In various embodiments; encoding device 200; may be a networked computing device generally capable of accepting requests over network 104, e.g., from decoding device 300, and providing responses accordingly. In various embodiments, decoding device 300 may be a networked computing device having a form factor such as a mobile phone; a watch, glass, or other wearable computing device; a dedicated media player; a computing tablet; a motor vehicle head unit; an audio-video on demand (AVOD) system; a dedicated media console; a gaming device, a “set-top box,” a digital video recorder, a television, or a general purpose computer. In various embodiments, network 104 may include the Internet, one or more local area networks (“LANs”), one or more wide area networks (“WANs”), cellular data networks, and/or other data networks. Network 104 may, at various points, be a wired and/or wireless network.

Referring to FIG. 2, several components of an exemplary encoding device 200 are illustrated. In some embodiments, an encoding device may include fewer or more components than those shown in FIG. 2. However, it is not necessary that all of these generally conventional components be shown in order to disclose an illustrative embodiment. As shown in FIG. 2, exemplary encoding device 200 includes a network interface 204 for connecting to a network, such as network 104. Exemplary encoding device 200 also includes a processing unit 208, a memory 212, an optional user input 214 (e.g. an alphanumeric keyboard, keypad, a mouse or other pointing device, a touchscreen, and/or a microphone), and an optional display 216, all interconnected along with the network interface 204 via a bus 220. The memory 212 generally comprises a RAM, a ROM, and/or a permanent mass storage device; such as a disk drive, flash memory, or the like.

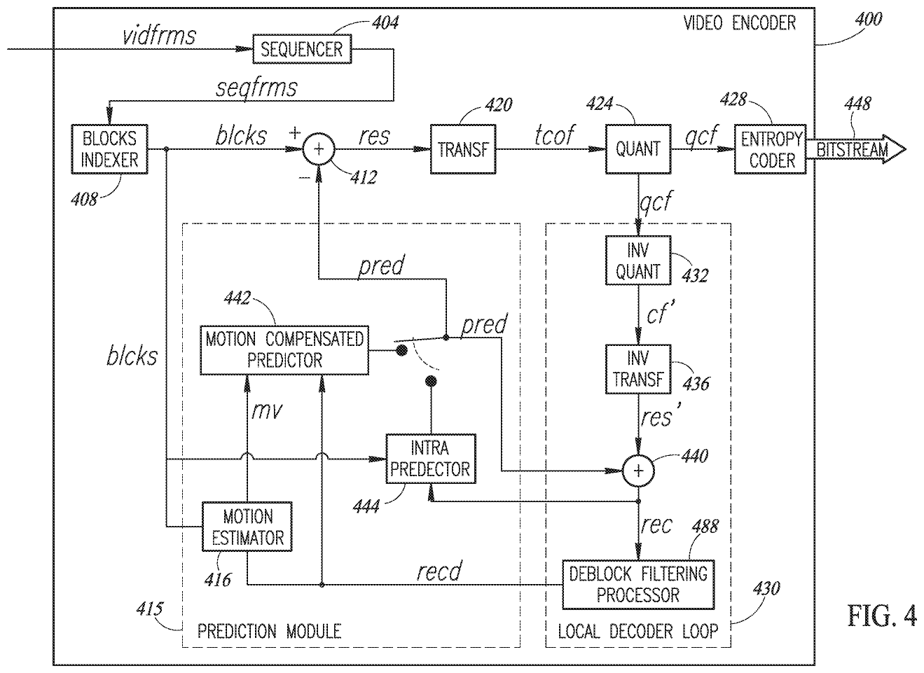

The memory 212 of exemplary encoding device 200 stores an operating system 224 as well as program code for a number of software services, such as a video encoder 238 (described below in reference to video encoder 400 of FIG. 4). Memory 212 may also store video data files (not shown) which may represent unencoded copies of audio/visual media works, such as, by way of examples, movies and/or television episodes. These and other software components may be loaded into memory 212 of encoding device 200 using a drive mechanism (not shown) associated with a non-transitory computer-readable medium 232, such as a floppy disc, tape, DVD/CD-ROM drive, memory card, or the like. Although an exemplary encoding device 200 has been described, an encoding device may be any of a great number of networked computing devices capable of communicating with network 104 and executing instructions for implementing video encoding software, such as exemplary video encoder 238 or video encoder 400 of FIG. 4.

In operation, the operating system 224 manages the hardware and other software resources of the encoding device 200 and provides common services for software applications, such as video encoder 238. For hardware functions such as network communications via network interface 204, receiving data via input 214, outputting data via display 216, and allocation of memory 212 for various software applications, such as video encoder 238, operating system 224 acts as an intermediary between software executing on the encoding device and the hardware.

In some embodiments, encoding device 200 may further comprise a specialized unencoded video interface 236 for communicating with unencoded-video source 108 (FIG. 1), such as a high speed serial bus, or the like. In some embodiments, encoding device 200 may communicate with unencoded-video source 108 via network interface 204. In other embodiments, unencoded-video source 108 may reside in memory 212 or computer readable medium 232.

Although an exemplary encoding device 200 has been described that generally conforms to conventional general purpose computing devices, an encoding device 200 may be any of a number of devices capable of encoding video, for example, a video recording device, a video co-processor and/or accelerator, a personal computer, a game console, a set-top box, a handheld or wearable: computing device, a smart phone, or any other suitable device.

Encoding device 200 may, by way of example, be operated in furtherance of an on-demand media service (not shown). In at least one exemplary embodiment, the on-demand media service may be operating encoding device 200 in furtherance of an online on-demand media store providing digital copies of media works, such as video content, to users on a per-work and/or subscription basis. The on-demand media service may obtain digital copies of such media works from unencoded video source 108.

Referring to FIG. 3, several components of an exemplary decoding device 300 are illustrated. In some embodiments, a decoding device may include fewer or more components than those shown in FIG. 3. However, it is not necessary that all of these generally conventional components be shown in order to disclose an illustrative embodiment. As shown in FIG. 3, exemplary decoding device 300 includes a network interface 304 for connecting to a network, such as network 104. Exemplary decoding device 300 also includes a processing unit 308, a memory 312, an optional user input 314 (e.g. an alphanumeric keyboard, keypad, a mouse or other pointing device, a touchscreen, and/or a microphone), an optional display 316, and an optional speaker 318, all interconnected along with the network interface 304 via a bus 320. The memory 312 generally comprises a RAM, a ROM, and a permanent mass storage device, such as a disk drive, flash memory, or the like.

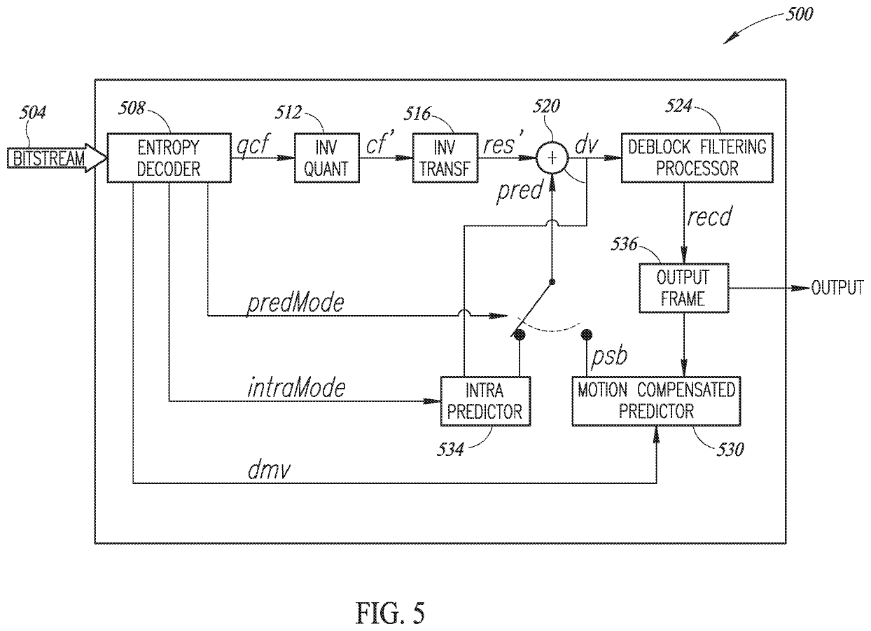

The memory 312 of exemplary decoding device 300 may store an operating system 324 as well as program code for a number of software services, such as video decoder 338 (described below in reference to video decoder 500 of FIG. 5). Memory 312 may also store video data files (not shown) which may represent encoded copies of audio/visual media works, such as, by way of example, movies and/or television episodes. These and other software components may be loaded into memory 312 of decoding device 300 using a drive mechanism (not shown) associated with a non-transitory computer-readable medium 332, such as a floppy disc, tape, DVD/CD-ROM drive, memory card, or the like. Although an exemplary decoding device 300 has been described, a decoding device may be any of a great number of networked computing devices capable of communicating with a network, such as network 104, and executing instructions for implementing video decoding software, such as video decoder 338.

In operation, the operating system 324 manages the hardware and other software resources of the decoding device 300 and provides common services for software applications, such as video decoder 338. For hardware functions such as network communications via network interface 304, receiving data via input 314, outputting data via display 316 and/or optional speaker 318, and allocation of memory 312, operating system 324 acts as an intermediary between software executing on the encoding device and the hardware.

In some embodiments, the decoding device 300 may further comprise an optional encoded video interface 336, e.g., for communicating with encoded-video source 112, such as a high speed serial bus, or the like. In some embodiments, decoding device 300 may communicate with an encoded-video source, such as encoded video source 112, via network interface 304. In other embodiments, encoded-video source 112 may reside in memory 312 or computer readable medium 332.

Although an exemplary decoding device 300 has been described that generally conforms to conventional general purpose computing devices, an decoding device 300 may be any of a great number of devices capable of decoding video, for example, a video recording device, a video co-processor and/or accelerator, a personal computer, a game console, a set-top box, a handheld or wearable computing device, a smart phone, or any other suitable device.

Decoding device 300 may, by way of example, be operated in furtherance of an on-demand media service. In at least one exemplary embodiment, the on-demand media service may provide digital copies of media works, such as video content, to a user operating decoding device 300 on a per-work and/or subscription basis. The decoding device may obtain digital copies of such media works from unencoded video source 108 via, for example, encoding device 200 via network 104.

FIG. 4 shows a general functional block diagram of software implemented video encoder 400 (hereafter “encoder 400”) employing residual transformation techniques in accordance with at least one embodiment. The video encoder 400 may be similar or identical to the video encoder 238 of the encoding device 200 shown in FIG. 2. One or more unencoded video frames (vidfrms) of a video sequence in display order may be provided to sequencer 404.

Sequencer 404 may assign a predictive-coding picture-type (e.g. I, P, or B) to each unencoded video frame and reorder the sequence of frames, or groups of frames from the sequence of frames, into a coding order for motion prediction purposes (e.g. I-type frames followed by P-type frames, followed by B-type frames). The sequenced unencoded video frames (seqfrms) may then be input in coding order to blocks indexer 408.

For each of the sequenced unencoded video frames (seqfrms), blocks indexer 408 may determine a largest coding block (“LCB”) size for the current frame (e.g. sixty-four by sixty-four pixels) and divide the unencoded frame into an array of coding blocks (blcks). Individual coding blocks within a given frame may vary in size, e.g. from four by four pixels up to the LCB size for the current frame.

Each coding block may then be input one at a time to differencer 412 and may be differenced with corresponding prediction signal blocks (pred) generated in a prediction module 415 from previously encoded coding blocks. To generate the prediction blocks (pred), coding blocks (blcks) are also provided to an intra-predictor 444 and a motion estimator 416 of the prediction module 415. After differencing at differencer 412, a resulting residual block (res) may be forward-transformed to a frequency-domain representation by transformer 420, resulting in a block of transform coefficients (tcof). The block of transform coefficients (tcof) may then be sent to a quantizer 424 resulting in a block of quantized coefficients (qcf) that may then be sent both to an entropy coder 428 and to a local decoder loop 430.

For intra-coded coding blocks, intra-predictor 444 provides a prediction signal representing a previously coded area of the same frame as the current coding block. For an inter-coded coding block, motion compensated predictor 442 provides a prediction signal representing a previously coded area of a different frame from the current coding block.

At the beginning of local decoding loop 430, inverse quantizer 432 may de-quantize the block of transform coefficients (cf′) and pass them to inverse transformer 436 to generate a de-quantized residual block (res′). At adder 440, a prediction block (pred) from motion compensated predictor 442 or intra predictor 444 may be added to the de-quantized residual block (res′) to generate a locally decoded block (rec). Locally decoded block (rec) may then be sent to a frame assembler and deblock filter processor 488, which reduces blockiness and assembles a recovered or reconstructed frame (recd), which may be used as the reference frame for motion estimator 416 and motion compensated predictor 442.

Entropy coder 428 encodes the quantized transform coefficients (qcf), differential motion vectors (dmv), and other data, generating an encoded video bit-stream 448. For each frame of the unencoded video sequence, encoded video bit-stream 448 may include encoded picture data (e.g. the encoded quantized transform coefficients (qcf) and differential motion vectors (dmv)) and an encoded frame header (e.g. syntax information such as the LCB size for the current frame).

FIG. 5 shows a general functional block diagram of a corresponding video decoder 500 (hereafter “decoder 500”) that implements inverse residual transformation techniques in accordance with at least one embodiment and that is suitable for use with a decoding device, such as decoding device 300. Decoder 500 may work similarly to the local decoding loop 430 of encoder 400 discussed above.

Specifically, an encoded video bit-stream 504 to be decoded may be provided to an entropy decoder 508, which may decode blocks of quantized coefficients (qcf), differential motion vectors (dmv), accompanying message data packets (msg-data), and other data, including the prediction mode (intra or inter). The quantized coefficient blocks (qcf) may then be reorganized by an inverse quantizer 512, resulting in recovered transform coefficient blocks (cf′). Recovered transform coefficient blocks (cf′) may then be inverse transformed out of the frequency-domain by an inverse transformer 516, resulting in decoded residual blocks (res′).

When the prediction mode for a current block is the inter prediction mode, an adder 520 may add motion compensated prediction blocks (psb) obtained by using corresponding motion vectors (dim) from a motion compensated predictor 530.

When the prediction mode for a current block is the intra prediction mode, a predicted block may be constructed on the basis of pixel information of a current picture. At this time, the intra predictor 534 may determine an intra prediction mode of the current block and may perform the prediction on the basis of the determined intra prediction mode. Here, when intra prediction mode-relevant information received from the video encoder is confirmed, the intra prediction mode may be induced to correspond to the intra prediction mode-relevant information.

The resulting decoded video (dv) may be deblock-filtered in a frame assembler and deblock filtering processor 524 (or “deblock filter”). Blocks (recd) at the output of frame assembler and deblock filtering processor 524 form a reconstructed or output frame 536 of the video sequence, which may be output from the video decoder 500 and also may be used as the reference frame for the motion compensated predictor 530 for decoding subsequent coding blocks.

As noted above, the coefficients of the residual signal may be transformed from the spatial domain to the frequency domain (e.g. using a discrete cosine transform (“DCT”) or a discrete sine transform (“DST”)). For naturally occurring images, such as the type of images that typically make up human perceptible video sequences, low-frequency energy is always stronger than high-frequency energy. Residual signals in the frequency domain therefore get better energy compaction than they would in spatial domain. After forward transform, the coefficients and motion vectors may be quantized and entropy encoded.

A transform generates an 8×8 (in this non-limiting example) block of coefficients that represent a “weighting” value for each of 64 orthogonal basis pattern that are added together to produce the original image. In the 8×8 block, the horizontal and vertical frequencies increase from the top left to the bottom right such that the upper left coefficient is a DC coefficient and the lower right is the highest AC frequency coefficient.

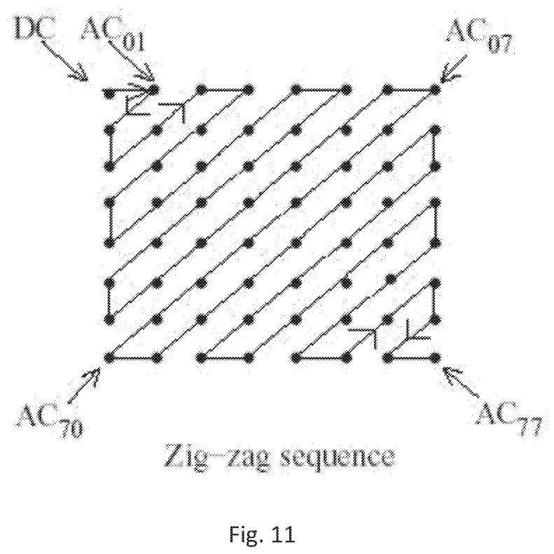

As noted above, the coding block may be pre-multiplied by a quantization scale code and divided element-wise by a quantization matrix, and rounding each resultant element. The quantization matrix may be designed to provide more resolution to more perceivable frequency components over less perceivable components (usually lower frequencies over high frequencies) in addition to transforming as many coefficients to 0, which can be encoded with greatest efficiency. The extent of the reduction may be varied by changing the quantization scale code, taking up much less bandwidth than a full quantization matrix. Typically this process will result in matrices with values primarily in the upper left (low frequency) corner. By using a zig-zag ordering (see FIG. 11) to group the non-zero entries and run length encoding, the quantized matrix can be much more efficiently stored than the non-quantized version.

Each coding block may also include or be assigned a quantization parameter (QP) which may correspond to or set the compression level of the processing block. As such, QP acts as a quality control parameter that balances quality and bitrate. The QP may vary for each CU in a frame. However, QP may not vary much from coding block to coding block. Thus, a “delta QP” value, which is difference between the desired QP and a predicted QP value, may be encoded in the stream rather than an absolute QP value, thus reducing storage requirements. As an example, the predicted value may be formed from the delta QP of neighboring coding blocks.

FIGS. 5-12C illustrate one or more implementations of the present disclosure that provide adaptive quantization parameters and adaptive quantization rounding offsets for use in quantizing the transform coefficients. In at least some implementations, a local sensitivity measurement is obtained for each coding unit or block, and a delta. QP of each coding block is determined based on the local sensitivity measurement. Non-limiting examples of local sensitivity measurements include one or more of luminance, local contrast, local contrast and gradient direction, motion intensity, motion intensity and motion direction, or any combinations thereof.

In at least some implementations, the encoder may determine a sensitivity ratio for each coding block. The determined sensitivity ratio may then be input into a function to determine a delta-QP value for the coding block. As an example, the system may calculate a local sensitivity for a coding block, as discussed above, and may also calculate an average sensitivity over a certain region of a frame (e.g., entire image or portion thereof) of which the coding block is a part. Equations (1) and (2) below show example formulas for determining the local sensitivity (is) and the average sensitivity (as), respectively, where c₁ and c₂ are constants, σᵢ² is the variance of coding unit i, and N is the number of coding units in the region of the frame under consideration.

$${ls}_{i} = {c}_{1} * {σ}_{i}^{2} + {c}_{2} \qquad ( 1 )$$

$$as = {\sum }_{i = 0}^{N} {ls}_{i} / N \qquad ( 2 )$$

The sensitivity ratio for the coding block may be equal to the local sensitivity divided by the average sensitivity (i.e., lsᵢ/as).

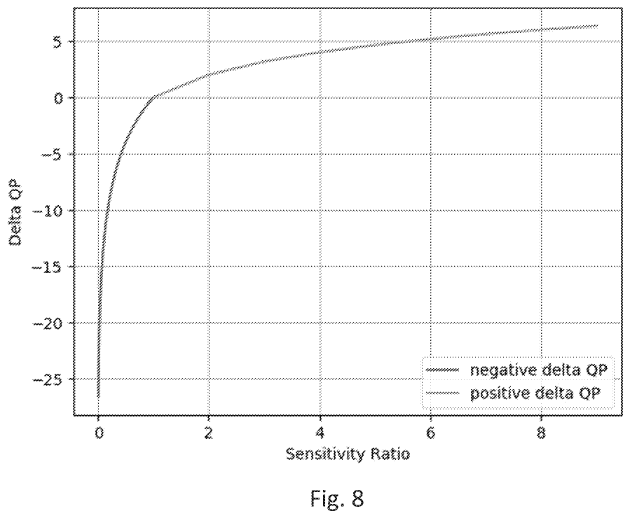

FIG. 8 illustrates a graph of an example piece-wise non-linear mapping function that is used to determine a delta-QP for each block based on the calculated sensitivity ratio for the block. Equation (3) below shows the formula for the function shown in FIG. 8.

$$Δ QP = \{ \begin{matrix}a * log 2 ( ls / as ) & if \frac{ls}{as} \geq 1 \\ b * log 2 ( ls / as ) & otherwise\end{matrix} , where b > a \qquad ( 3 )$$

When the sensitivity ratio is equal to or greater than one, delta QP is positive which provides bitrate savings while maintaining similar visual quality. When the sensitivity is less than one, delta QP is negative which provides improved quality.

Although the piece-wise non-linear function is provided as an example, it should be appreciated that other functions may be used to provide the functionality discussed herein. In at least some implementations, a suitable or optimized function may be determined using one or more machine learning techniques.

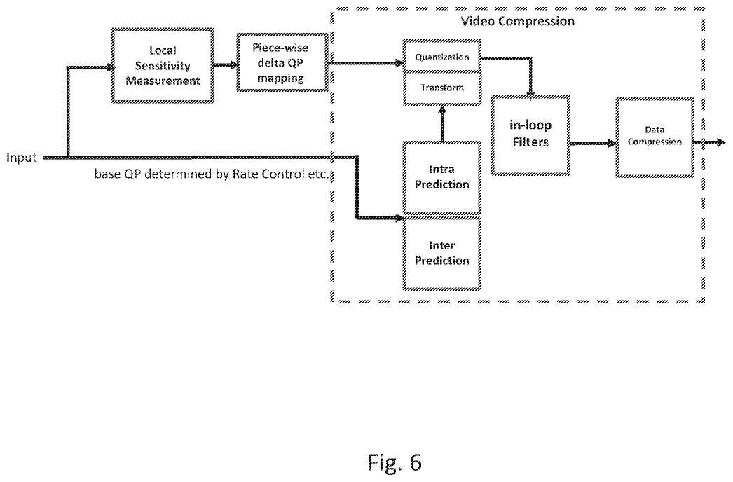

FIG. 6 shows an example block diagram of an encoder that performs local sensitivity measurement on each coding block and determines a delta-QP for the coding block using a piece-wise delta-QP mapping function or other function. The determined delta-QP is provided to a quantizer of video encoder.

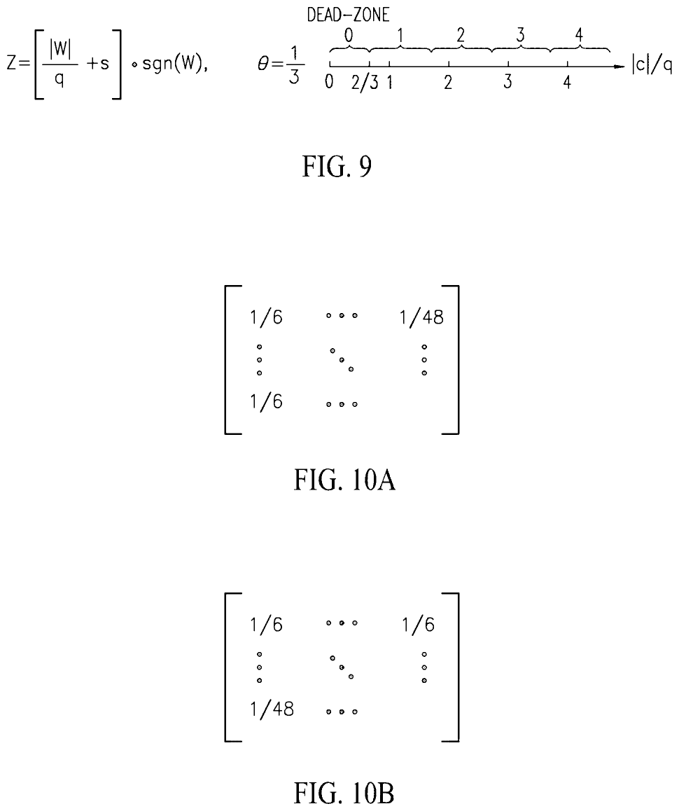

FIGS. 9-10B illustrate one or more implementations of the present disclosure that provide frequency dependent adaptive rounding offsets for the transform coefficients at the coding block level based on determined local sensitivity. FIG. 9 shows an example formula for determining the transform coefficients, where q is the quantization step, W is the transform coefficients, and s is a rounding offset. The smaller the rounding offset is, the larger the dead zone. As an example, for HEVC, the fixed rounding offset for intra-coded coding blocks is 1/3 and the fixed rounding offset is 1/6 for inter-coded coding blocks is 1/6.

In at least some implementations of the present disclosure, the rounding offsets may vary by frequency based on the determined local sensitivity (e.g., intensity and direction), as discussed above. FIG. 10A illustrates an example adaptive rounding offset matrix for high motion intensity in the horizontal direction, wherein the rounding offsets are smaller for higher horizontal frequencies, FIG. 10B illustrates an example adaptive rounding offset matrix for high motion intensity in the vertical direction, where the rounding offsets are smaller for higher vertical frequencies.

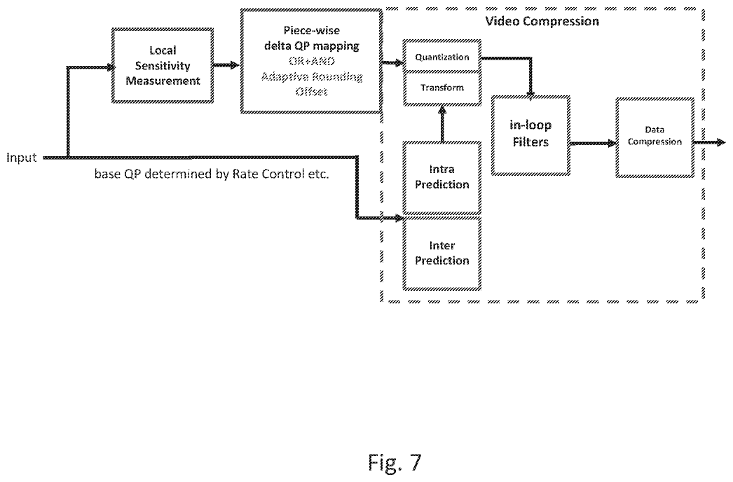

FIG. 7 shows an example block diagram of an encoder that performs local sensitivity measurement on each coding block and determines a delta-QP for the coding block using a piece-wise delta-QP mapping function or other function. The encoder of FIG. 7 also calculates adaptive rounding offsets based on the local sensitivity measurement. The determined delta-QP and adaptive rounding offsets are provided to a quantizer of video encoder.

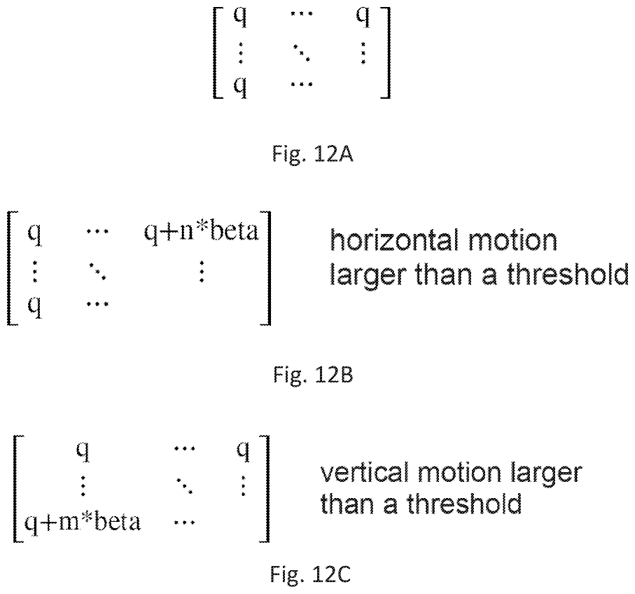

FIGS. 12A-12C illustrate an implementation of the present disclosure that provides an adaptive quantization step based on local sensitivity measurements. In particular, FIG. 12A shows an initial quantization matrix that is filled with the value q, which is a uniform scalar quantization step for an entire block. FIGS. 12B and 12C show modifying the values of the quantization step based on local sensitivity measurements, in this non-limiting example, motion intensity and direction information. In particular, FIG. 12B shows an example quantization matrix for horizontal motion that is greater than a threshold, wherein larger quantization steps are provided for higher horizontal frequencies. FIG. 12C shows an example quantization matrix for vertical motion that is greater than a threshold, wherein larger quantization steps are provided for higher vertical frequencies. In other implementations, the quantization matrix may be dependent on other combinations of determined local sensitivity measurements, as discussed above.

The foregoing detailed description has set forth various implementations of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one implementation, the present subject matter may be implemented via Application Specific Integrated Circuits (ASICs). However, those skilled in the art will recognize that the implementations disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

Those of skill in the art will recognize that many of the methods or algorithms set out herein may employ additional acts, may omit some acts, and/or may execute acts in a different order than specified.

In addition, those skilled in the art will appreciate that the mechanisms taught herein are capable of being distributed as a program product in a variety of forms, and that an illustrative implementation applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory.

The various implementations described above can be combined to provide further implementations. These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A method for encoding a video stream, comprising:
obtaining a coding block from an unencoded video frame of the video stream that is to be encoded into an encoded bit-stream;
measuring a local sensitivity of the coding block;
determining at least one of:
one or more quantization parameters based at least in part on the local sensitivity measurement;
one or more adaptive rounding offsets based at least in part on the local sensitivity measurement; or
one or more quantization steps based at least in part on the local sensitivity measurement; and
providing the at least one of the one or more quantization parameters, adaptive rounding offsets or quantification steps to a quantizer of a video encoder for use in encoding the coding block of the unencoded video frame.
